(19) United States
(12) Patent Application Publication
(10) Pub. No.: US 2026/0325886 A1
(43) Pub. Date: Oct. 22, 2026

(54) Barrier Membrane Assembly

(71) Applicant: Dräger Safety AG & Co. KGaA, Lübeck (DE)

(72) Inventors: Gordon Wrigley, Gosforth (GB); Darin Ferguson, Ashington (GB); Craig Stuart Blenkiron, Prudhoe (GB)

(21) Appl. No.: 19/648,871

(22) Filed: Apr. 15, 2026

(30) Foreign Application Priority Data
Apr. 22, 2025 (EP) 25171726.0

(51) Int. Cl. A62B 23/02; A62B 9/02

(52) U.S. Cl. CPC A62B 23/02; A62B 9/022

(57) ABSTRACT

A barrier membrane assembly for a lung demand regulator of a breathing apparatus may include an outer ring having a first clamping feature, and an inner ring having a second clamping feature corresponding to the first clamping feature; and a barrier membrane for resisting permeation of one or more CBRN materials; wherein the first clamping feature engages the second clamping feature to clamp a peripheral edge of the barrier membrane between the outer ring and the inner ring. Also disclosed is a lung demand regulator, and a breathing apparatus.

### CROSS-REFERENCE TO RELATED APPLICATIONS

This application claims priority to European Application No. 25 171 726.0, filed on April 22, 2025 and entitled “Barrier Membrane Assembly,” the entirety of which is hereby incorporated by reference in its entirety for all non-limiting purposes.

### TECHNICAL FIELD

The present disclosure relates to barrier membrane assemblies, and more specifically to barrier membrane assemblies for lung demand regulators.

### BACKGROUND

Firefighters and other emergency personnel are regularly faced with responding to incidents in challenging and often dangerous environments. These environments are often categorised as immediately dangerous to life or health (IDLH). IDLH environments may include environments with toxic or harmful gases or particulates (such as smoke) which, if inhaled, could lead to sickness or death. In order to operate in IDLH environments, firefighters use self-contained breathing apparatus (SCBA) system. These systems provide the user with safe, breathable gas on demand from a compressed gas supply, so that they are not at risk of breathing in any harmful environmental components.

However, some environments in which firefighters or other personnel operate necessitate even greater protections due to the increased risks they pose. Such environments may include chemical, biological, radiological, and/or nuclear (CBRN) materials. SCBA systems must function in these environments while ensuring the safety of the user.

It will, therefore, be appreciated that improvements which enable breathing apparatus systems to more effectively function in CBRN environments are desirable.

### SUMMARY

Aspects of the present disclosure will now be described.

According to a first aspect, there is provided a barrier membrane assembly for a lung demand regulator of a breathing apparatus. The barrier membrane assembly may comprise an outer ring having a first clamping feature. The barrier membrane assembly may comprise and an inner ring having a second clamping feature corresponding to the first clamping feature. The barrier membrane assembly may comprise a barrier membrane for resisting permeation of one or more CBRN materials.

The first clamping feature may engage the second clamping feature to clamp a peripheral edge of the barrier membrane between the outer ring and the inner ring. The term “engages” may be understood to mean “connect to”, “clamp against”, and/or “interlock with”. The outer ring and the inner ring may be arranged concentrically.

The barrier membrane may comprise a flat (e.g., 2-dimensional) circular shape before incorporation into the barrier membrane assembly. Once incorporated into the barrier membrane assembly, the barrier membrane may comprise a 3-dimensional domed shape.

The barrier membrane may only be clamped at its peripheral edge. The term “peripheral edge” may refer to an outermost edge of the barrier membrane. The term “peripheral edge” may additionally or alternatively refer to an outermost boundary of the barrier membrane. For example, the term “peripheral edge” may refer to a boundary beginning at an outermost edge of the barrier membrane and extending up to 1% or up to 5% or up to 10% of a width of the barrier membrane inwards.

The barrier membrane, the inner ring, and outer ring may, when engaged, may form the barrier membrane assembly as a substantially unitary component. The barrier membrane assembly may be configured as a replaceable component of a lung demand regulator of a breathing apparatus.

The inner ring and the outer ring may be independent components which are not formed as an integral part of the lung demand regulator.

The outer ring and inner ring, when engaged, may form a structural ring frame for the barrier membrane. The structural ring frame may be configured to be engaged by a corresponding portion or portions of the lung demand regulator so as to connect the barrier membrane assembly to the lung demand regulator.

It will be appreciated that, before being connected to a lung demand regulator, the barrier membrane assembly exists as a separate, independent, and complete assembly distinct from the lung demand regulator. The barrier membrane assembly can be connected as a unitary component into a lung demand regulator.

The first clamping feature may be a first circumferential clamping feature arranged on an inner surface of the outer ring. The second clamping feature may be a second circumferential clamping feature arranged on an outer surface of the inner ring.

One of the first clamping feature and the second clamping feature may be a protruding clamping feature. The other of the first clamping feature and the second clamping feature may be a recessed clamping feature which receives the protruding clamping feature.

The first clamping feature may be a first flat clamping feature. The second clamping feature may be a second flat clamping feature. A peripheral edge of the barrier membrane may be clamped between the first and second flat clamping features.

The outer ring may comprise a plurality of clamping features. The inner ring may comprise a plurality of corresponding clamping features.

The second clamping feature may be a protruding clamping feature. The first clamping feature may be a recessed clamping feature which receives the protruding clamping feature. The protruding clamping feature may comprise an apex, or a pointed tip.

The outer ring may comprise a first axial clamping feature. The inner ring may comprise a second axial facing clamping feature. The first axial clamping feature may correspond to the second axial clamping feature.

The second axial clamping feature may be a protruding clamping feature. The first axial clamping feature may be a recessed clamping feature which receives the protruding clamping feature to clamp an annular portion of the barrier membrane between the outer ring and the inner ring.

The outer ring may comprise a shrouding extending from the outer ring. The shrouding may protect and/or cover a portion of an outer surface of the barrier membrane. The shrouding may protect the portion of the outer surface of the barrier membrane from contact with other objects. The shrouding may cause the barrier membrane to conform a contour of the shrouding.

The barrier membrane may comprise an adhesive layer to adhere the portion of the outer surface of the barrier membrane to the shrouding.

The shrouding may comprise an axially extending portion and an inwardly tapering portion. The inwardly tapering portion may be a conical or frustoconical portion. The inwardly tapering portion may extend from an end of the axially extending portion.

The peripheral edge of the barrier membrane may be deformed between the first clamping feature and the second clamping to prevent removal of the barrier membrane from between the outer ring and the inner ring.

The barrier membrane may be permanently deformed. The term “permanently deformed” may be understood to mean plastically, inelastically, and/or irreversibly deformed.

At least one of the outer ring and the inner ring may comprise a circular cross section. The protruding clamping feature may comprise a rounded or blunt tip.

The outer ring and the inner ring may snap fit together to clamp the peripheral edge of the barrier membrane between the outer ring and the inner ring.

The outer ring and the inner ring being snap fit together may result in a permanent connection therebetween. That is to say, once the outer ring and the inner ring are snap fit together, they may not be separated and/or may be inseparable.

The barrier membrane assembly may comprise an adhesive layer between the first clamping feature and the barrier membrane and/or between the second clamping feature and the barrier membrane. The barrier membrane assembly may comprise an adhesive layer between the outer ring and the inner ring to hold the outer ring and the inner ring together.

A compressive force may be exerted on the peripheral edge of the barrier membrane by the outer ring and the inner ring to prevent removal of the barrier membrane from between the outer ring and the inner ring.

According to a second aspect, there is provided a lung demand regulator comprising a barrier membrane assembly according to the first aspect.

According to a third aspect, there is provided a breathing apparatus comprising a barrier membrane assembly according to the first aspect and/or a lung demand regulator according to the second aspect.

According to a fourth aspect, there is provided a method of manufacturing a barrier membrane assembly for preventing permeation of at least one CBRN component into a lung demand regulator of a breathing apparatus. The method may comprise providing a support ring structure having a first ring portion with a first diameter and a second ring portion with a second diameter, smaller than the first diameter. The method may comprise deforming a peripheral edge of a barrier membrane over the first ring portion and against the second ring portion to prevent removal of the barrier membrane from the support ring structure over the first ring portion.

The support ring structure of the fourth aspect may be equivalent to the inner ring of the first aspect. The method of the fourth aspect may be applicable to manufacturing the barrier membrane assembly of the first aspect.

The method forms the barrier membrane assembly as a substantially unitary component from the support ring structure and the barrier membrane. The barrier membrane assembly may be configured as a replaceable component of a lung demand regulator of a breathing apparatus.

The support ring structure may be an independent component which is not formed as an integral part of the lung demand regulator.

The support ring structure may form a structural ring frame for the barrier membrane. The structural ring frame may be configured to be engaged by a corresponding portion or portions of the lung demand regulator so as to connect the barrier membrane assembly to the lung demand regulator.

It will be appreciated that, before being connected to a lung demand regulator, the barrier membrane assembly exists as a separate, independent, and complete assembly distinct from the lung demand regulator. The barrier membrane assembly may be connected as a unitary component into the lung demand regulator, once assembled according to the methods disclosed herein.

The entire peripheral edge of the barrier membrane may be deformed. In other words, the entire perimeter of the barrier membrane may be deformed.

The support ring structure may be a unitary component. That is to say, the first ring portion and the second ring portion may be formed together. For example, the first ring portion and the second ring portion may be formed together by moulding or additive manufacturing to form the support ring structure as a single component.

The first diameter may be a first outer diameter and the second diameter may be a second outer diameter. The first ring portion may comprise a first inner diameter and the second ring portion may comprise a second inner diameter. The first inner diameter and the second inner diameter may be equal.

The support ring structure may comprise an annular shape having circular opening in the centre.

The support ring structure may comprise a third ring portion on an opposite side of the second ring portion to the first ring portion. The third ring portion may have a third diameter larger than the second diameter.

The third diameter may be equal to the first diameter. In other words, the first, second, and third ring portions may define an inset circumferential groove on an outer surface of the support ring structure. The groove may have a depth equal to a difference between the first diameter and the second diameter and/or between the third diameter and the second diameter.

The support ring structure comprises a tapered portion between the first ring portion and the second ring portion, the tapered portion varying in diameter between the first diameter adjacent the first ring portion and the second diameter adjacent the second ring portion.

The support ring structure may comprise an additional tapered portion between the third ring portion and the second ring portion. The additional tapered portion may vary in diameter between the third diameter adjacent the third ring portion and the second diameter adjacent the second ring portion.

The first ring portion may be an upper ring portion and the second ring portion is a lower ring portion arranged concentrically with the upper ring portion.

In this context, the terms ‘upper’ and ‘lower’ may indicate to a relative orientation of the support ring structure. The upper ring portion may be ‘above’ the lower ring portion. During deformation, the peripheral edge of the barrier membrane may be deformed over the upper ring portion before being deformed against the lower ring portion. Thus, an introduction direction in which the barrier membrane is introduced to the support ring structure may point from the upper ring portion toward the lower ring portion. Deformation of the peripheral edge of the barrier membrane may prevent the barrier membrane from being withdrawn from the support ring structure in a direction opposite to the introduction direction.

The method may comprise deforming a central portion of the barrier membrane over a convex jig to impart a corresponding convex shape to the central portion of the barrier membrane.

Deforming the peripheral edge of the barrier membrane over the first ring portion and against the second ring portion may comprise deforming the peripheral edge of the barrier membrane to conform to the second diameter of the second ring portion. Deforming may include heat shrinking and/or vacuum forming.

The term “conform” may be interpreted as meaning “take the shape of”, optionally in a permeant or irreversible manner.

Once the peripheral edge of the barrier membrane is conformed to the second diameter of the second ring portion, the barrier membrane may not be removed from the support ring structure.

Heat shrinking the peripheral edge of the barrier membrane to conform to the second diameter of the second ring portion may prevent removal of the barrier membrane from the support ring structure by preventing the peripheral edge of the barrier membrane from being drawn over the first ring portion.

The method may comprise providing an outer ring having an inner circumferential surface corresponding to the first diameter and/or the second diameter. The method may comprise snap-fitting the outer ring onto the support ring structure to clamp the peripheral edge of the barrier membrane between the outer ring and the support ring structure.

An outer surface of the support ring structure, defined by the varying diameters of the first ring portion and the second ring portion, may be referred to as a first clamping feature.

The inner circumferential surface of the outer ring that corresponds to the outer surface of the support ring structure may be referred to as a second clamping feature. The first clamping feature may correspond to the second clamping feature.

Prior to deforming the peripheral edge of the barrier membrane, the method may comprise applying a layer of adhesive to the first ring portion and/or the second ring portion to adhere the peripheral edge of the barrier membrane to the first ring portion and/or the second ring portion.

The peripheral edge of the barrier membrane may be permanently deformed over the first ring portion and against the second ring portion. The term “permanently” will be understood to mean “irreversibly”. That is, once deformed, the peripheral edge of the barrier membrane cannot be reverted to its previous or original shape.

The barrier membrane may be permanently deformed. The term “permanently deformed” may be understood to mean plastically, inelastically, and/or irreversibly deformed.

Once the peripheral edge of the barrier membrane is deformed over the first ring portion and against the second ring portion, the peripheral edge of the barrier membrane may be held in tension to thereby apply a compressive force to the second ring portion.

According to a fifth aspect, there is provided a barrier membrane assembly manufactured according to the method the fourth aspect.

The barrier membrane assembly may be for preventing permeation of at least one CBRN component into a lung demand regulator of a breathing apparatus. The barrier membrane assembly may comprise: a barrier membrane and a support ring structure having a first ring portion with a first diameter and a second ring portion with a second diameter, smaller than the first diameter.

A peripheral edge of a barrier membrane may be deformed over the first ring portion and against the second ring portion to prevent removal of the barrier membrane from the support ring structure over the first ring portion.

The peripheral edge of the barrier membrane may be conformed to the second diameter of the second ring portion. The peripheral edge of the barrier membrane may be conformed to the second diameter of the second ring portion by heat shrinking and/or by vacuum forming.

The support ring structure may comprise a third ring portion on an opposite side of the second ring portion to the first ring portion. The third ring portion may have a third diameter larger than the second diameter.

The support ring structure may comprise a tapered portion between the first ring portion and the second ring portion. The tapered portion may vary in diameter between the first diameter adjacent the first ring portion and the second diameter adjacent the second ring portion.

The first ring portion may be an upper ring portion. The second ring portion may be a lower ring portion arranged concentrically with the upper ring portion.

A layer of adhesive may be provided on the first ring portion and/or the second ring portion to adhere the peripheral edge of the barrier membrane to the first ring portion and/or the second ring portion.

The third diameter may be equal to the first diameter. In other words, the first, second, and third ring portions may define an inset circumferential groove on an outer surface of the support ring structure. The groove may have a depth equal to a difference between the first diameter and the second diameter and/or between the third diameter and the second diameter.

The support ring structure may comprise an additional tapered portion between the third ring portion and the second ring portion. The additional tapered portion may vary in diameter between the third diameter adjacent the third ring portion and the second diameter adjacent the second ring portion.

According to a sixth aspect, there is provided a lung demand regulator comprising a barrier membrane assembly according to the fifth aspect.

### BRIEF DESCRIPTION OF THE DRAWINGS

Arrangements of the disclosure will now be described, by way of example, and with reference to the accompanying drawings, in which:

FIG. 1 schematically shows a breathing apparatus;

FIG. 2 schematically shows a lung demand regulator connected to a breathing apparatus;

FIGS. 3A and 3B schematically show cross-sectional views of a portion of the lung demand regulator of FIG. 2;

FIG. 4 schematically shows a cross-sectional perspective view of a barrier membrane assembly according to an embodiment of the present disclosure;

FIGS. 5A-5E schematically show cross-sectional views of various barrier membrane assemblies according to embodiments of the present disclosure;

FIGS. 6A and 6B schematically show cross-sectional views of various support ring structures according to embodiments of the present disclosure;

FIG. 7 shows a flowchart of a method according to an embodiment of the present disclosure;

FIGS. 8A-8C depict various method steps according to embodiments of the present disclosure; and

FIG. 9 depicts a method step according to an embodiment of the present disclosure.

### DETAILED DESCRIPTION OF THE DRAWINGS

As discussed above, breathing apparatus systems often require additional measures to protect users from harm in CBRN environments. One particular area that requires consideration is protection of the flexible diaphragm that exists in many types of breathing apparatus system. Specifically, breathing apparatus systems which include a lung demand regulator generally comprise a flexible diaphragm. The diaphragm is exposed to the ambient environment on one side and exposed to breathing gas supplied to the user on the other. It can be possible for CBRN materials to permeate through the diaphragm from the ambient environment, into the breathing gas supplied to the user, putting the user at risk. A barrier membrane can be used to cover the ambient environment side of the diaphragm to prevent CBRN materials from contacting and permeating through the diaphragm. The present disclosure provides improvements to assemblies comprising such barrier membranes.

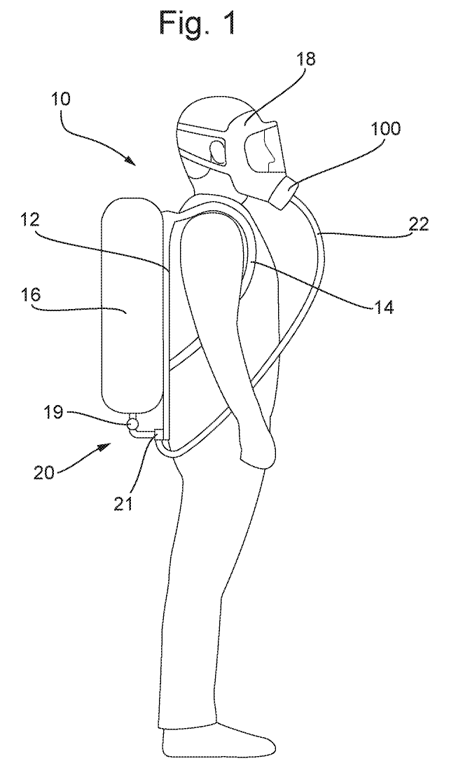

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a flexible conduit or hose 22 to the lung demand regulator 100, to thereby deliver breathing gas to the user wearing the face mask 18 on demand. The pneumatics system 20 is connected to the breathing gas cylinder 16 by a valve 19. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus 10 is a self-contained breathing apparatus (SCBA), but it should be understood that the lung demand regulator may also have applications in other types of breathing apparatus, such as self-contained underwater breathing apparatus (SCUBA) and emergency escape breathing apparatus.

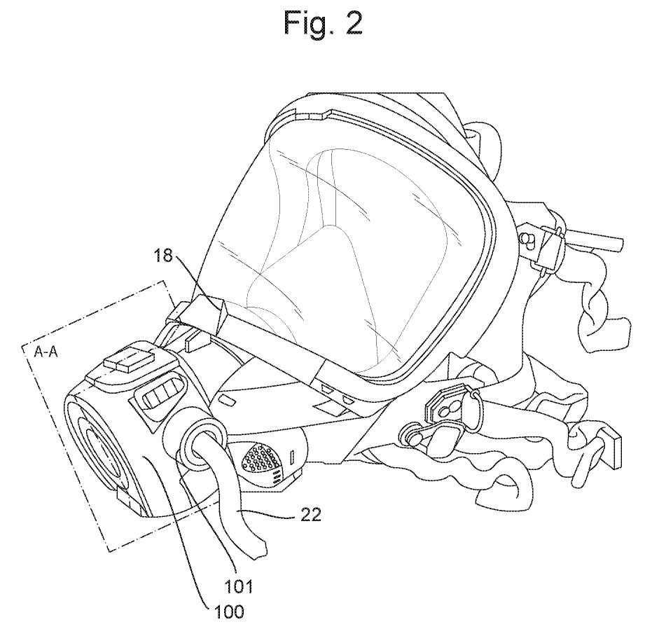

Turning to FIG. 2, a schematic view of the face mask 18 attached to the regulator 100 is shown. The hose 22 of the pneumatics system 20 is connected to an inlet 101 of the regulator 100 to provide breathing gas from the cylinder 16. The pneumatics system 20 comprises a first-stage pressure reducer 21 which reduces the pressure of the breathing air from the cylinder 16 which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided.

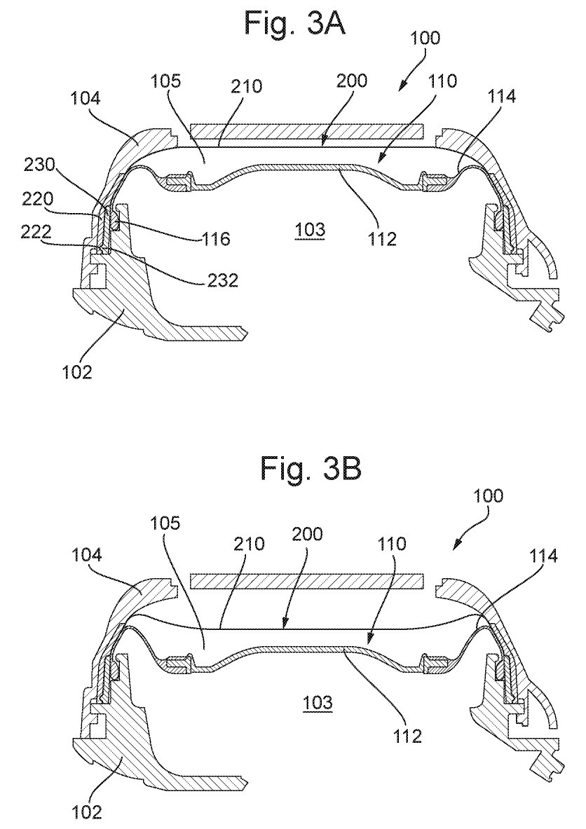

Turning to FIG. 3A, a cross-sectional view of a portion of the regulator 100 is shown along the plane A-A in FIG. 2. The regulator 100 includes a diaphragm 110 disposed in a body 102 of the regulator 100. The regulator 100 also comprises an end cap 104. The diaphragm 110, together with the body 102, defines an internal chamber 103. The diaphragm 110 is exposed on a first side to the internal chamber 103. In the embodiment shown, the diaphragm 110 comprises a substantially inflexible or rigid central portion 112 which is surrounded by a flexible peripheral portion 114. The peripheral portion 114 connects the diaphragm 110 to the body 102 and permits the central portion to move in and out relative to the internal chamber 103.

For ease of understanding, the regulator valve mechanism itself is not shown in FIGS. 3A and 3B. However, it should be understood that the regulator 100 comprises a regulator valve mechanism including a demand valve (not shown) which is coupled to the diaphragm 110. In some embodiments, an actuation lever of the demand valve engages the diaphragm 110 to provide mechanical coupling therebetween. When a user inhales through the regulator 100, a pressure in the internal chamber 103 decreases relative to the ambient pressure. As a result, the diaphragm 110 moves inwards, into the internal chamber 103 (downwards from the perspective of FIG. 3). This inward movement results in actuation of the demand valve to open the demand valve, causing breathing gas to enter the internal chamber 103. The introduction of breathing gas into the internal chamber 103 increase the pressure in the internal chamber 103, which results in the diaphragm 110 returning to its original position and the demand valve closing. The cycle then repeats once the user takes another breath.

The regulator 100 is fitted with a barrier membrane assembly 200. It will be appreciated that the barrier membrane assembly 200 may be a separate (and optionally replaceable) component of the regulator 100, which can be installed into the regulator 100 to augment the functionality of the regulator 100. The barrier membrane assembly 200 comprises a barrier membrane 210 which is capable of resisting permeation of at least one CBRN material. The barrier membrane 210 may be substantially impermeable to at least one CBRN material. The possible physical characteristics of the barrier membrane 210 are described in more detail below.

In embodiments of the disclosure, a central portion of the barrier membrane 210 is separated from the central portion 112 of the diaphragm 110. Between a second side of the diaphragm 110 and the barrier membrane 210 is a generally sealed gas pocket 105. Therefore, the barrier membrane assembly 200 prevents the second side of the diaphragm 110 (or indeed any part of the diaphragm 110) from being exposed directly to the ambient environment. As a result, the barrier membrane assembly 200 prevents CBRN materials in the ambient environment from contacting and/or permeating the diaphragm 110.

To ensure proper functioning of the diaphragm 110 as described above, the barrier membrane 210 is flexible and thus effectively moves with the diaphragm 110 as the diaphragm 110 moves in response to changes of pressure in the internal chamber 103.

FIG. 3B shows the diaphragm 110 after it has moved inwards, towards the internal chamber 103. The barrier membrane 210 has also flexed inwards. The barrier membrane 210 and the gas pocket 105 enable the diaphragm 110 to experience the ambient pressure without being directly exposed to it. In this way, the diaphragm 110 can respond to changes of pressure in the internal chamber 103 relative to the ambient pressure, without being directly exposed to the ambient environment.

By providing separation between the diaphragm 110 and the barrier membrane 210 as shown, the diaphragm 110 can move freely without any resistance from the barrier membrane 210. As a result, performance variations of the diaphragm 110 are minimised. Further, a user of the regulator 100 will feel minimal (if any) differences between breathing through a regulator 100 fitted with a barrier membrane assembly 200 compared to one without.

In some embodiments, the diaphragm 110 may be biased by a biasing apparatus (not shown). The biasing apparatus may be disposed between the end cap 104 and the barrier membrane. The biasing apparatus may comprise a spring and a plate. The plate may rest on the barrier membrane 210 and the spring may apply an force to the barrier membrane 210 in inward direction, towards the internal cavity 103. The gas pocket 105 may transfer the biasing force applied to the barrier membrane 210 to the diaphragm 110.

The barrier membrane 210 may be formed of a material substantially impermeable to at least one CBRN material. The barrier membrane 210 may prevent, restrict, or inhibit certain types of CBRN materials, such as those which may typically be encountered by persons working in hazardous environments, from permeating through the diaphragm 110. This may ensure that a person using the lung demand valve does not inhale CBRN materials that may be present in the ambient atmosphere. The barrier membrane 210 may be sufficiently resistant to the permeation of CBRN materials such that, when used with the diaphragm 110, and/or a lung demand regulator 100 (i.e., when the barrier membrane assembly 200 is fitted therein), the barrier membrane 210 complies with certain CBRN requirements. The CBRN requirements may be NIOSH 42 CFR 84.63 and/or BS8468-I 2006. The barrier membrane 210 may be deformable. The barrier membrane 210 may be substantially continuous. In other words, the barrier membrane 210 may not have any openings or holes that would allow CBRN materials to pass through to the diaphragm 110. The barrier membrane 210 may comprise a plastics material. The plastics material may comprise polyvinylidene fluoride (PVDF), polyvinyl fluoride (PVF), or polyether ether ketone (PEEK). The barrier membrane 210 may have a thickness of between 0.001 mm and 0.05 mm, or between 0.002 mm and 0.03 mm, or between 0.003 mm and 0.02 mm. The thickness may be less than 0.05 mm, or less than 0.03 mm, or less than 0.02 mm. The barrier membrane 210 may not be bonded or otherwise adhered or connected to the diaphragm 110. Rather, the barrier membrane 210 may be separated from the diaphragm 110.

As shown in FIGS. 3A and 3B, the barrier membrane 210 is secured in the barrier membrane assembly 200 at a peripheral edge of the barrier membrane 210. The barrier membrane assembly 200 is then attached, as a whole, to the body 102 of the regulator 100.

The peripheral edge of the barrier membrane 210 will generally be understood to be an annular band of the barrier membrane 210 at the outer edge/circumference of the barrier membrane 210. The annular band may have a thickness corresponding to between 1% and 15% of the diameter of the barrier membrane 210.

The peripheral edge of the barrier membrane 210 is clamped between an outer ring 220 of the barrier membrane assembly 200 and an inner ring 230 of the barrier membrane assembly 200. The outer ring 220 comprises a first clamping feature 222 and the inner ring 230 comprises a second clamping feature 232 which corresponds to the first clamping feature 222. The first clamping feature 222 engages the second clamping feature 232 to clamp the peripheral edge of the barrier membrane 210 between the outer ring 220 and the inner ring 230.

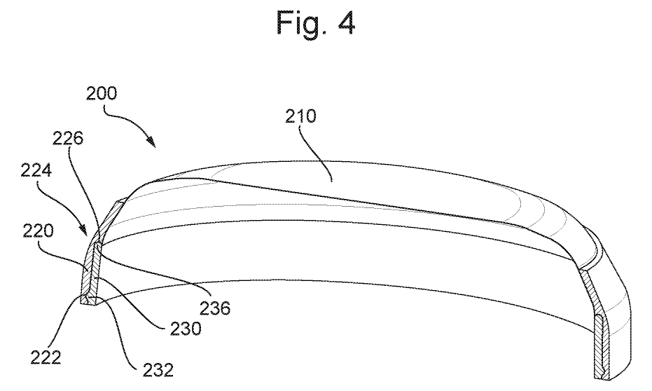

FIG. 4 shows a cross-sectional perspective view of the barrier membrane assembly 200 in isolation from the regulator 100. The first clamping feature 222 is a circumferential clamping feature arranged on an inner surface of the outer ring 220. In other words, the first clamping feature faces radially inwards from the outer ring 220. The second clamping features 232 is also a circumferential clamping feature arranged on an outer surface of the inner ring 230. In other words, the second clamping feature 232 faces radially outwards from the inner ring 230. Therefore, when the outer ring 220 is arranged concentrically around the inner ring 230, the outer clamping feature 222 is facing the inner clamping feature 232 such that they can engage each other.

In some of the embodiments according to the present disclosure, one of the first clamping feature and the second clamping is a protruding clamping feature and the other of the first clamping feature and the second clamping feature is a recessed clamping feature which receives the protruding clamping feature. As shown in FIG. 4, the first clamping feature 222 is a recessed clamping feature and the second clamping feature 232 is a protruding clamping feature. The first clamping feature 222 receives the second clamping feature 232 with the peripheral edge of the barrier membrane 210 in between.

In this embodiment, the second clamping feature 232 comprises a tapered or pointed tip. In other words, the second clamping feature 232 comprises surfaces that join at an apex furthest from the outer surface of the inner ring 230. When the outer ring 220 and the inner ring 230 are snap fit together, the pointed tip concentrates a compressive force at a small area of the peripheral edge of the barrier membrane 210, thereby increasing the pressure applied thereto. As a result, the barrier membrane 210 is clamped between the outer ring 220 and the inner ring 230 and is prevented from being removed. The peripheral edge of the barrier membrane 210 is deformed between the first clamping features 222 and the second clamping feature 232 when clamped therebetween. Deformation of the peripheral edge of the barrier membrane 210 may include local stretching (e.g., elastic deformation) of the barrier membrane 210 over the protruding inner clamping feature 232 and/or plastic deformation of the barrier membrane 210.

The outer ring 220 also comprises a shrouding 224. The shrouding 224 extends from the outer ring 220 in a generally axial direction. The shrouding 224 covers a portion of the barrier membrane 210 adjacent to the peripheral edge of the barrier membrane 210. In the embodiment shown, the shrouding 224 comprises an axially extending portion and an inwardly tapering portion leading on from the axially extending portion. The inwardly tapering portion could be considered to be a frustoconical portion.

The shrouding 224 protects the barrier membrane 210 and prevents the barrier membrane 210 from contacting a peripheral edge of the end cap 104 when the barrier membrane assembly 200 is installed in the regulator 100. As shown, depending on the shape of the shrouding 224, the shrouding 224 may cause the barrier membrane 210 to conform to the contour of the shrouding 224.

As noted above, the barrier membrane 210 can, for example, be wrapped over the inner ring 230 and then the outer ring 220 can be snap fit onto the inner ring 230 to clamp the barrier membrane 210 in place, thereby forming the barrier membrane assembly 200. Once assembled, the barrier membrane assembly 200 can be installed into the regulator 100.

Referring back to FIGS. 3A and 3B, the fully assembled and complete barrier membrane assembly 200 can be placed over the diaphragm 110. In the embodiment shown, an inner surface of the inner ring 230 presses against a peripheral bead 116 of the diaphragm 110. This has two effects. Firstly, the pressure exerted by the barrier membrane assembly 200 against the peripheral bead 116 causes the diaphragm 110 to be held in place. Secondly, a reactionary force exerted by the peripheral bead 116 against the barrier membrane assembly 200 causes the barrier membrane assembly 200 to be held in place.

Once the barrier membrane assembly 200 is installed over the diaphragm 110, the end cap 104 can be attached. In the embodiment shown, the end cap 104 is threaded and is screwed onto a corresponding thread of the body 102. By screwing the end cap 104 onto the body 102, a pressure is applied to the outer ring 220 of the barrier membrane assembly 200, preventing movement of the barrier membrane assembly 200 inside the regulator 100. Notably, the outer ring 220 and the shrouding 224 (when present) prevent the end cap 104 from contacting the barrier membrane 210. Therefore, as the end cap 104 is screwed onto the body 102, the barrier membrane 210 is not twisted or otherwise distorted by the end cap 104. It will be appreciated that, were the barrier membrane 210 to be distorted by the end cap 104, this could lead to variations in performance of the regulator 100 and/or potentially impact the protection from CBRN materials offered by the barrier membrane assembly 200.

Returning to FIG. 4, the outer ring 220 further comprises a first axial clamping feature 226 and the inner ring 230 comprises a second axial clamping feature 236 which corresponds to the first axial clamping feature 226. In this embodiment, the second axial clamping feature 236 is a protruding axial clamping feature and the first axial clamping feature 226 is a recessed axial clamping feature which receives the second axial clamping feature 236. An annular portion of the barrier membrane 210 adjacent to the peripheral edge of the barrier membrane 210 is clamped between the first axial clamping feature 226 and the second axial clamping feature 236. As a result, the annular portion of the barrier membrane 210 is deformed to bend radially outwards. This additional deformation further prevents removal of the barrier membrane 210 from between the outer ring 220 and the inner ring 230 by increasing the number of surfaces which contact the barrier membrane 210, resulting in greater frictional forces. The first axial clamping feature 226 and the second axial clamping feature 236 also interact to increase the strength with which the outer ring 220 and the inner ring 230 are snap fit together.

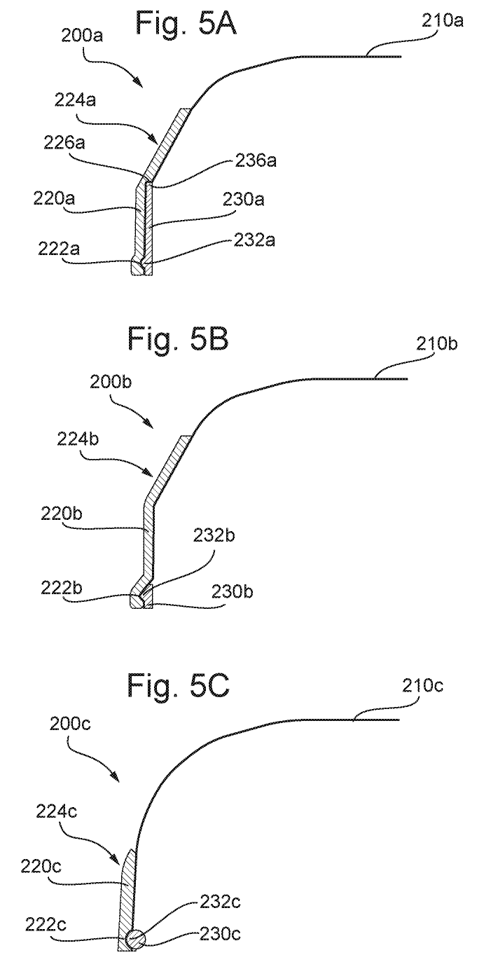

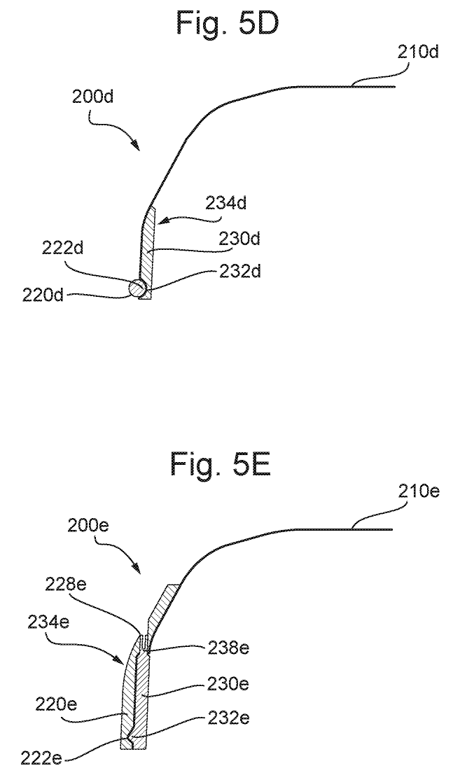

FIGS. 5A-5E show sectional views of various embodiments of the barrier membrane assembly 200.

FIG. 5A shows a sectional view of the barrier membrane assembly 200a that is similar to the barrier membrane assembly 200 of FIG. 4. In this embodiment, the first clamping feature 222a and the second clamping feature 232a remain as recessed and protruding clamping features, respectively. However, the first axial clamping feature 226a and the second axial clamping feature 236a of this embodiment are each flat axial clamping features. Therefore, the barrier membrane 210a is clamped between the first axial clamping feature 226a and the second axial clamping feature 236a without necessarily being deformed therebetween. The shrouding 224a is similar to that of the embodiment of FIG. 4 and, again, conforms the barrier membrane 210a to the shape thereof.

FIG. 5B shows a sectional view of another barrier membrane assembly 200b. In this embodiment, the inner ring 230b is significantly shorter than the outer ring 220b and is primarily comprised of the protruding second clamping feature 232b. The recessed first clamping feature 222b is significantly larger than in the previously described embodiments, which results in the inner ring 230b (when connected to the outer ring 220b) being substantially in line with the outer ring 220b. The larger respective first and second clamping features 222b, 232b result in greater deformation of the peripheral edge of the barrier membrane 210b. Therefore, although the inner ring 230b is smaller than in previous embodiments, the clamping force exerted on the barrier membrane 210b is still adequate to prevent removal of the barrier membrane 210b from between the outer ring 220b and the inner ring 230b. As with the previous embodiments, the outer ring 220b also includes a shrouding 224b which conforms the barrier membrane 210b to the shape thereof.

FIG. 5C shows a sectional view of another barrier membrane assembly 200c. This barrier membrane assembly 200c is similar to the barrier membrane assembly 200b of FIG. 5B in that the inner ring 230c is significantly smaller than the outer ring 220c. In this embodiment, the inner ring 230c comprises a circular cross section. As a result, the protruding second clamping surface 232c is a convex portion of the circular cross section which engages a correspondingly concave recessed first clamping surface 222c. The inner ring 230c can be connected (e.g., by being snap fit) into the recessed clamping surface 222c to clamp the peripheral edge of the barrier membrane 210c therebetween. In this embodiment, the shrouding 224c is shorter than in the previous embodiments, and does not comprise a tapered portion. As a result, the barrier membrane 210c only conforms to the shape of the axial portion of the shrouding 224c.

FIG. 5D shows an embodiment of a barrier membrane assembly 200d with a reversed configuration compared with the barrier membrane assembly 200c of FIG. 5C. In this embodiment, the outer ring 220d comprises a circular cross section. As a result, the protruding first clamping surface 222d is a convex portion of the circular cross section which engages a correspondingly concave recessed second clamping surface 232d. The outer ring 220d can be connected (e.g., by being snap fit) into the recessed clamping feature 232d to clamp the peripheral edge of the barrier membrane 210d therebetween. In this embodiment, the outer ring 220d does not comprise a shrouding. However, the inner ring 230d does comprise a shrouding 234d which engages an inner surface of the diaphragm 210d to conform to the shape of the shrouding 234d.

FIG. 5E shows another embodiment of a barrier membrane assembly 200e. The barrier membrane assembly 200e comprises an inner ring 230e which comprises a locking feature 238e. The locking feature 238e engages a corresponding locking feature 228e of the shrouding 234e. The engagement between the locking feature 238e and the corresponding locking feature 228e provides additional connection strength between the outer ring 220e and the inner ring 230e, besides the clamping of the first engagement surface 222e and the second engagement surface 232e.

In some embodiments, an adhesive layer between the outer ring 220 and the barrier membrane 210 and/or between the inner ring 230 and the barrier membrane 210 may be provided. The or each adhesive layer may further secure the barrier membrane 210 between the outer ring 220 and the inner ring 230. The or each adhesive layer may be localised to the first clamping feature 222 and/or the second clamping feature 232. The or each adhesive layer may additionally provide an airtight seal between the outer ring 220 and the barrier membrane 210 and/or between the inner ring 230 and the barrier membrane 210. In other embodiments, no adhesive layer may be required to adequately clamp the barrier membrane 210 between the outer ring 220 and the inner ring 230. It will, therefore, be appreciated that the use of adhesive to connect the barrier membrane 210 to the outer ring 220 and/or the inner ring 230 is not necessarily required.

As will be appreciated, embodiments of the barrier membrane assembly 200 described herein clamp the barrier membrane 210 at a peripheral edge of the barrier membrane 210. This ensures the barrier membrane 210 is robustly held in place while still permitting free movement of the barrier membrane 210 when the barrier membrane assembly 200 is in use in a regulator 100.

Although embodiments of the barrier membrane assembly have been described as being for protecting a diaphragm of a lung demand regulator, it will be appreciated that the embodiments described herein are equally applicable to protecting diaphragms comprised in any other pneumatic component of a breathing apparatus.

According to some embodiments, the barrier membrane 210 may be attached to an inner ring 230 in such a way that the barrier membrane 210 cannot be removed from the inner ring 230, even without the presence of an outer ring 220. In such embodiments, the inner ring 230 is referred to as a support ring structure 300 as it provides the necessary support to the barrier membrane 210 to form the barrier membrane assembly 200 without an outer ring 220.

It will be appreciated that to enable the barrier membrane 210 to be attached to the support ring structure 300 so that the barrier membrane 210 cannot be removed from the support ring structure 300, a particular shape of the support ring structure 300 is required.

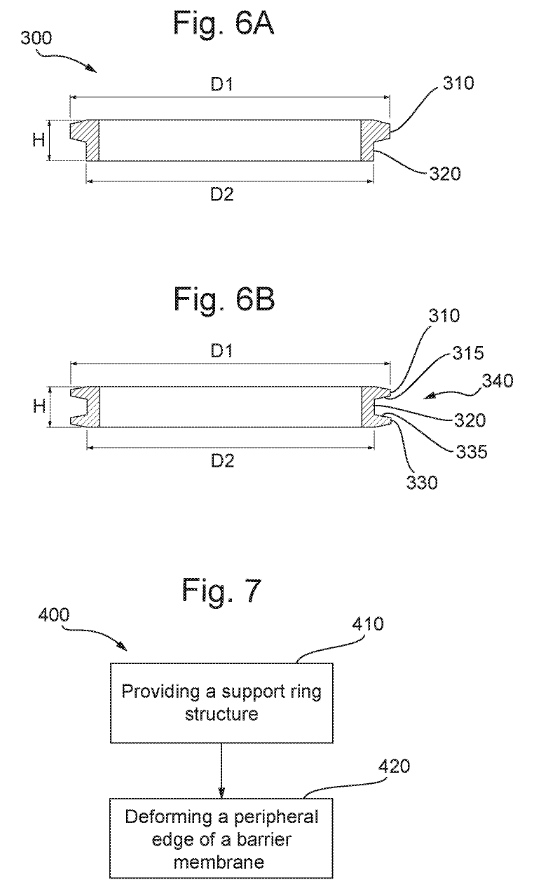

FIG. 6A shows a cross-sectional view of an embodiment of a support ring structure 300. As shown, the support ring structure 300 comprises a first ring portion 310 and a second ring portion 320. The first ring portion 310 comprises a first outer diameter D1 and the second ring portion 320 comprises a second outer diameter D2. The first diameter D1 is larger than the second diameter D2. In this embodiment, the internal diameters of the first and second ring portions 310, 320 are the same. The first and second ring portions 310, 320 may be formed together as a unitary support ring structure 300. In this embodiment, the first ring portion 310 is shown as having tapered edges and the second ring portion 320 as having a flat edge. However, in other embodiments, the first ring portion may have flat edges and/or the second ring portion may have tapered edges. Of course, the view shown in FIG. 6A is a schematic view and simply serves to illustrate the features of the support ring structure 300, rather than specify any particular dimensions of the support ring structure 300. In particular, a ratio of the thickness H (i.e., the axial ‘height’) of the support ring structure 300 compared to the first and second diameters D1, D2 may be different to that illustrated. Specifically, the ratio may be larger. That is to say, the first and second diameters D1, D2 may be much greater than depicted compared to the thickness H.

The first diameter D1 may be between 70 mm and 72 mm. The second diameter D2 may be between 68 mm and 70 mm. The first diameter D1 may be at least 2 mm larger than the second diameter D2. The thickness H of the support ring structure 300 may be between 4 mm and 7 mm. In some embodiments, a ratio of the first diameter D1 to the thickness H may be between 18:1 and 10:1.

As will be appreciated, the first ring portion 310 of the support ring structure 300 may be considered an upper ring portion 310 and the second ring portion 320 may be considered a lower ring portion 320. The upper ring portion 310 may be arranged above the lower ring portion 320. The upper ring portion 310 may be arranged coaxially with the lower ring portion 320.

FIG. 6B shows a cross-sectional view of another embodiment of a support ring structure 300. In this embodiment, the support ring structure 300 comprises a third ring portion 330 which is disposed on the opposite side of the second ring portion 320 to the first ring portion 310. In this embodiment, the third ring portion 330 has a third diameter equal to the first diameter D1, though in other embodiments the third diameter may be different. The combination of the first, second, and third ring portions 310, 320, 330 may form an inset groove 340 in the supporting ring structure 300. The barrier membrane 210 may be deformed into the groove 340.

In some embodiments, the support ring structure 300 may comprise one or more tapered portion 315, 335 between the first ring portion 310 and the second ring portion 320 (and/or between the third ring 330 portion and the second ring portion 320. Such tapered portions 315, 335 may vary in diameter to provide a transition between adjacent ring portions 310, 320, 330.

Notably, support ring structures according to embodiments of the present disclosure can take any form, so long as they comprise a first ring portion that has a larger diameter than a second ring portion, with the first and second ring portions being offset in the axial direction.

In order attach the barrier membrane 210 to the support ring structure 300, a manufacturing method is followed. The method is a method of manufacturing a barrier membrane assembly 200. The method may be executed by a working using handheld equipment, and/or by machinery on, for example, a production line such as an automated production line.

FIG. 7 shows a flowchart of the method 400 according to an embodiment of the present disclosure. At step 410, the method 400 comprises providing a support ring structure 300 as described above. The support ring structure 300 comprises a first ring portion 310 with a first diameter D1 and a second ring portion 320 with a second diameter D2. The second diameter D2 is smaller than the first diameter D1.

At step 420, the method 400 comprises deforming a peripheral edge of a barrier membrane 210 over the first ring portion 310 and against the second ring portion 320 to prevent removal of the barrier membrane 210 from the support ring structure 300 over the first ring portion 310.

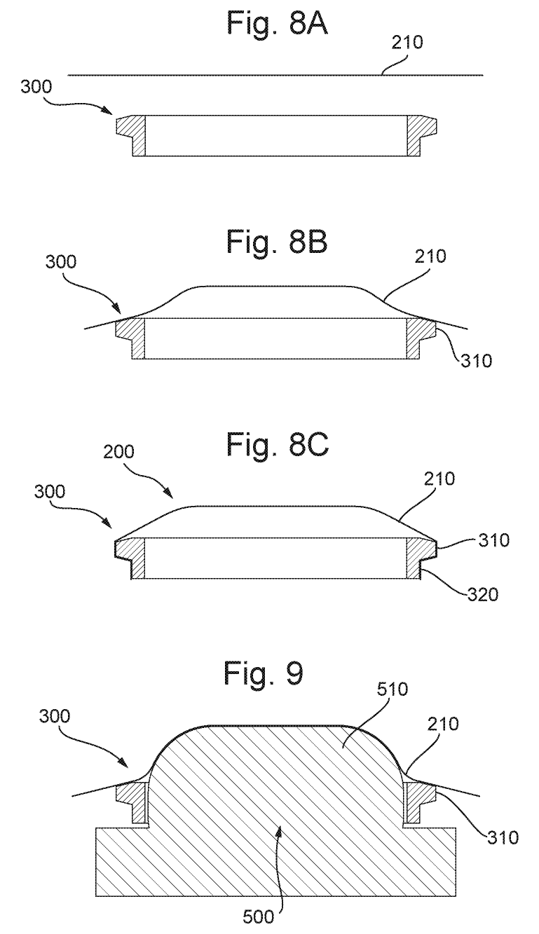

FIG. 8A depicts an embodiment of step 410 of the method 400. The support ring structure 300 of FIG. 6A (as an example) is provided. An, as yet, undeformed barrier membrane 210 is also provided. FIG. 8B depicts a first part of step 420 of the method 400 – deforming the barrier membrane over the first ring portion 310 of the support ring structure 300. FIG. 8C depicts a second part of step 420 of the method 400 – deforming the barrier membrane against the second ring portion 320 of the support ring structure 300.

By deforming the peripheral edge of the barrier membrane 210 against the second ring portion 320, the barrier membrane 210 is prevented from being removed from the support ring structure 300, because the peripheral edge (that now conforms to the second diameter D2) is too tight to be drawn back over the first ring portion 310. As a result, the method 400 forms a barrier membrane assembly 200 as a substantially unitary component from the support ring structure 300 and the barrier membrane 210. In some embodiments, the peripheral edge of the barrier membrane is deformed against the second ring portion 320 by a heat shrink process whereby the peripheral edge shrinks to the size of the second diameter D2.

Referring to FIG. 9, in some embodiments of the method according to the present disclosure, a jig 500 may be used. In such embodiments, the method may comprise an intervening step in which the support ring structure 300 is first loaded onto a jig 500 by, for example, using the centre opening of the support ring structure 300 to centre the support ring structure 300 on the jig 500. Next, the barrier membrane 210 may be deformed as before, but this time a central portion of the barrier membrane 210 is deformed over the jig before the peripheral edge of the barrier membrane 210 is deformed as described above. The step depicted in FIG. 9 is equivalent to that of FIG. 8A, but FIG. 9 shows the use of the jig 500. In some embodiments, the jig 500 may comprise a convex portion 510 which imparts a corresponding convex or domed shape to the central portion of the barrier membrane 210 during the deformation process.

It will be appreciated that, once the barrier membrane has been deformed over the jig 500, over the first ring portion 310, and against the second ring portion 320, the barrier membrane assembly 200 and can then be removed from the jig 500. At this point, the barrier membrane assembly 200 (as a complete and effectively unitary component) can be fitted into a regulator 100. The support ring structure 300 may engage one or more portions of the regulator 100 to form a secure connection therewith.

All of the methods described herein involve deforming the peripheral edge of the barrier membrane 210 to conform to the second diameter of second ring portion 320. This may result in the peripheral edge of the barrier membrane 210 being held in tension to thereby exert a compressive force on the support ring structure 300. As described above, this prevents the barrier membrane 210 from being removed from the support ring structure 300.

By deforming the barrier membrane 210 according to the method as described above, the barrier membrane 210 can be securely and reliably attached to the structural ring support 300 to form the barrier membrane assembly 200, without the need for adhesives. It will be appreciated that deforming the barrier membrane 210 as described herein will generally involve permanently deforming the barrier membrane 210 over the first ring portion 310 and against the second ring portion 320.

The methods of deformation as described herein may comprise heat forming and/or vacuum forming.

Some embodiments of the method described herein may further comprise providing an outer ring (such as the outer ring 220 described previously) which has an inner circumferential surface that corresponds to the first diameter D1 and/or the second diameter D2. The outer ring 220 may be snap fit onto the support ring structure 300 to clamp the peripheral edge of the barrier membrane between the outer ring 220 and the support ring structure. In such embodiments, the method may result in a barrier membrane assembly 200 that comprises a barrier membrane 210, a support ring structure 300, and an outer ring 220, which can then be installed into a regulator 100.

It will be appreciated by those skilled in the art that although the invention has been described by way of example, with reference to one or more exemplary embodiments, it is not limited to the disclosed embodiments and alternative embodiments could be constructed without departing from the scope of the invention as defined by the appended claims.

1. A method of manufacturing a barrier membrane assembly for preventing permeation of at least one CBRN component into a lung demand regulator of a breathing apparatus, the method comprising:
providing a support ring structure having a first ring portion with a first diameter and a second ring portion with a second diameter, smaller than the first diameter;
deforming a peripheral edge of a barrier membrane over the first ring portion and against the second ring portion to prevent removal of the barrier membrane from the support ring structure over the first ring portion.

2. The method of claim 1, wherein the first diameter is a first outer diameter and the second diameter is a second outer diameter, and wherein the first ring portion comprises a first inner diameter and the second ring portion comprises a second inner diameter, wherein the first inner diameter and the second inner diameter are equal.

3. The method of claim 1, wherein the support ring structure comprises a third ring portion on an opposite side of the second ring portion to the first ring portion, the third ring portion having a third diameter larger than the second diameter.

4. The method of claim 1, wherein the support ring structure comprises a tapered portion between the first ring portion and the second ring portion, the tapered portion varying in diameter between the first diameter adjacent the first ring portion and the second diameter adjacent the second ring portion.

5. The method of claim 1, wherein the first ring portion is an upper ring portion and the second ring portion is a lower ring portion arranged concentrically with the upper ring portion.

6. The method of claim 1, comprising deforming a central portion of the barrier membrane over a convex jig to impart a corresponding convex shape to the central portion of the barrier membrane.

7. The method of claim 1, wherein deforming the peripheral edge of the barrier membrane over the first ring portion and against the second ring portion comprises deforming the peripheral edge of the barrier membrane to conform to the second diameter of the second ring portion by heat shrinking, or vacuum forming, or combinations thereof.

8. The method of claim 1 further comprising:
providing an outer ring having an inner circumferential surface corresponding to the first diameter and/or the second diameter; and
snap-fitting the outer ring onto the support ring structure to clamp the peripheral edge of the barrier membrane between the outer ring and the support ring structure.

9. The method of claim 1, wherein prior to deforming the peripheral edge of the barrier membrane, the method comprises:
applying a layer of adhesive to the first ring portion and/or the second ring portion to adhere the peripheral edge of the barrier membrane (210) to the first ring portion and/or the second ring portion.

10. The method claim 1, wherein the peripheral edge of the barrier membrane is permanently deformed over the first ring portion and against the second ring portion.

11. The method of claim 1, wherein once the peripheral edge of the barrier membrane is deformed over the first ring portion and against the second ring portion, the peripheral edge of the barrier membrane is held in tension to apply a compressive force to the second ring portion.

12. A barrier membrane assembly for preventing permeation of at least one CBRN component into a lung demand regulator of a breathing apparatus, the barrier membrane assembly comprising:
a barrier membrane; and
a support ring structure having a first ring portion with a first diameter and a second ring portion with a second diameter, smaller than the first diameter;
wherein a peripheral edge of a barrier membrane is deformed over the first ring portion and against the second ring portion to prevent removal of the barrier membrane from the support ring structure over the first ring portion.

13. The barrier membrane assembly of claim 12, wherein the peripheral edge of the barrier membrane is conformed to the second diameter of the second ring portion , by heat shrinking, or vacuum forming, or combinations thereof.

14. The barrier membrane assembly of claim 12, wherein:
the support ring structure comprises a third ring portion on an opposite side of the second ring portion to the first ring portion, the third ring portion having a third diameter larger than the second diameter;
the support ring structure comprises a tapered portion between the first ring portion and the second ring portion, the tapered portion varying in diameter between the first diameter adjacent the first ring portion and the second diameter adjacent the second ring portion;
the first ring portion is an upper ring portion and the second ring portion is a lower ring portion arranged concentrically with the upper ring portion; and/or
a layer of adhesive is provided on the first ring portion and/or the second ring portion to adhere the peripheral edge of the barrier membrane to the first ring portion and/or the second ring portion.

15. A lung demand regulator comprising the barrier membrane assembly according to claim 12.
